(19) United States
(12) Patent Application Publication
(10) Pub. No.: US 2010/0281165 A1
(43) Pub. Date: Nov. 4, 2010

(54) METHOD FOR THE LOAD DISTRIBUTION IN A PEER-TO-PEER-OVERLAY NETWORK

(76) Inventors: Christoph Gerdes, Munchen (DE); Steffen Rusitschka, Munchen (DE); Alan Southall, Walldorf (DE)

Correspondence Address: STAAS & HALSEY LLP, SUITE 700, 1201 NEW YORK AVENUE, N.W., WASHINGTON, DC, 20005, US

(21) Appl. No.: 12/312,509

(22) PCT Filed: Oct. 16, 2007
(86) PCT No.: PCT/EP2007/060994

§ 371 Date: May 14, 2009

(30) Foreign Application Priority Data
Nov. 14, 2006 (DE) 10 2006 053 643.6

(51) Int. Cl. G06F 15/16

(52) U.S. Cl. 709/226

(57) ABSTRACT

A method provides for the even load distribution in a peer-to-peer-overlay network having a plurality of peers, each having an associated keyword region. A data resource to be stored, the keyword thereof being within the keyword region of a peer, is only stored with said peer if the number of data resources stored there has not reached a resource threshold limit.

### CROSS REFERENCE TO RELATED APPLICATIONS

This application is based on and hereby claims priority to PCT Application No. PCT/EP2007/060994 filed on Oct. 16, 2007 and German Application No. 10 2006 053 643.6 filed on Nov. 14, 2006, the contents of which are hereby incorporated by reference.

### BACKGROUND OF THE INVENTION

The invention relates to a method for the even load distribution in a peer-to-peer overlay network comprising a plurality of peers. In a peer-to-peer network all peers or nodes of the network have equality of access and can both use and provide services. No central database is provided in a peer-to-peer network, instead each peer of the peer-to-peer network provides a portion of the existing data, i.e. no peer of the peer-to-peer network administers all of the data stock. Furthermore, with a peer-to-peer network no central instance or central node is provided which controls or coordinates data transfer operations or interactions. Each peer of the peer-to-peer network works for itself autonomously. Furthermore, no peer of the peer-to-peer network has an overview of the structure of the entire peer-to-peer network. Each peer knows only the peers with which it directly interacts.

Peer-to-peer systems have proven to be efficient and scalable technology for storing and locating data. The opposite of the peer-to-peer principle is the client-server principle. Networks are generally subdivided into peer-to-peer networks with symmetrical data communication and client-server networks with asymmetrical data communication. With client-server networks there is a server, which provides a service, and a client, which uses this service. In contrast thereto this role allocation is removed in peer-to-peer networks. Each host in a computer network constitutes a peer with equality of access and can take on client and server functions simultaneously. With peer-to-peer networks a distinction can be made between unstructured peer-to-peer networks and structured peer-to-peer networks, which have a predefined topology. In particular in the case of structured peer-to-peer systems there are provided for example distributed hash tables DHT and these are continuously used by the applications running on the peer-to-peer network. One of the most well-known known DHT methods is Chord. As the data resources in a peer-to-peer network are distributed among the different peers, it is necessary to localize the node or peer which stores a specific data resource. With Chord this is a peer-to-peer algorithm for locating a data resource within a peer-to-peer network. For this purpose the physical peer-to-peer network is mapped on a peer-to-peer overlay network. With Chord the nodes or peers are mapped in a ring structure, with a specific keyword range being allocated to each peer within the ring structure. The known search algorithm for locating a data resource within the peer-to-peer network starts from a uniform distribution of the keywords. With a ring comprising m peers and n data resources to be stored, n:m data resources are filed per peer.

FIGS. 1a, 1b show a simple example of a Chord ring structure for a peer-to-peer network according to the related art. Each peer has an associated peer ID, for example peer ID=1, peer ID=2, peer ID=3, peer ID=4. If a peer is within the Chord ring, it is allocated a specific keyword range. In the simple example shown in FIG. 1a each keyword comprises just three bits.

FIG. 1b shows the distribution of the keyword range among the four peers of the peer-to-peer network. Three keywords, namely “000”, “001”, “010” are allocated to the first peer P1. Only one keyword “011” is allocated to the second peer P2. Two keywords “100” and “101” are allocated to the third peer P3 and the fourth peer P4 in turn has two keywords “110” and “111”. With real applications the keywords comprise more than three bits, for example a 128 bit character chain. These keywords are preferably hash values which are formed from a data record name by a hash function or from a data record or data resource itself. The data resource can be any desired data record or data, for example an optical image comprising many bits. A hash value H is derived from this data resource by a hash function. The hash value H is derived from a keyword or the key which has been allocated to the data resource. The data resource is filed with the peer of the peer-to-peer network in whose associated keyword range the hash value H or the keyword of the data resource falls.

If, for example, the hash value H or the keyword of a data resource is “010” the data resource is filed with peer P1. A data resource, whose keyword is “101”, for example, will be filed with peer P3 within the Chord ring.

With reference to the simple example relating to a Chord ring shown in FIG. 1, FIGS. 2a, 2b show publication or storing of a data resource within the peer-to-peer network. If, for example, a searching peer P3 wants to store a data resource with the keyword “010”, with the procedure illustrated in FIG. 2a, it firstly asks an adjacent peer P4 whether the keyword falls within its keyword range. If this is not the case, as in the example shown in FIG. 2a, peer P4 in turn asks its neighbor peer P1. As the keyword falls within the keyword range of peer P1, peer P1 communicates this to the predecessor peer P4, which in turn communicates this to the querying peer P3. Peer P3 then stores the data resource relating to keyword “010” with peer P1.

In the alternative procedure shown in FIG. 2b the querying peer P3 firstly asks the adjacent peer P4 and receives therefrom a reference to the adjacent peer P1. Peer P3 then establishes in the case of peer P1 whether the keyword of the data resource to be stored falls within its keyword range or not. If this is the case, as in the example given, peer P1 communicates this to peer P3 and then the data resource is stored by peer P3 with the located peer P1.

One drawback of known peer-to-peer networks and the known method of storing and reading-out data resources lies in the fact that the frequency of keywords is not evenly distributed, but, as a rule, a few keywords occur much more frequently than other keywords. By way of example, in a telephone book application the keyword “Maier” will occur much more frequently in the German-speaking area than a relatively rarer name like “Gerdes” for example. A user who wants to store a data resource usually assigns a name or a keyword in order to be able to subsequently locate this data resource again. If, for example, the data resource is an image or a photo, the user assigns a suitable name. If a landscape is depicted on the image for example, a user can allocate the keyword “landscape” for example as the keyword or as metadata of the data resource. Similar themes are thus often given the same keyword. In most applications for storing data resources there is no uniform distribution of keywords, instead what is known as Zipf distribution, i.e. a few keywords are very common, while the majority of the remaining keywords tend to occur rarely.

With a known peer-to-peer network this leads to overloading of individual peers and therefore to destabilization of the entire peer-to-peer network. Peers, whose allocated keyword range contains frequently occurring keywords, have to store significantly more data resources than other peers in whose allocated keyword range only rarely occurring keywords are located. The memory capacity of these peers is quickly exhausted accordingly.

### SUMMARY

It is therefore one potential object to create a method for the even load distribution in a structured peer-to-peer network.

The inventors propose a method for the even load distribution in a peer-to-peer overlay network comprising a plurality of peers, each having an associated keyword range, wherein a data resource to be stored, whose keyword is within the keyword range of a peer, is only stored with said peer if the number of data resources stored there has not yet reached a resource threshold limit.

In one embodiment of the proposed method, a peer, which has reached its resource threshold limit, refers to a peer that is adjacent in the peer-to-peer-overlay network.

In one embodiment of the proposed method the keyword is formed by a hash value.

In one embodiment of the proposed method the adjacent peer is a subsequent peer in a search path in the peer-to-peer overlay network.

In one embodiment of the proposed method the resource threshold limit of a peer is separately set in each case.

In one embodiment of the proposed method a peer, which has a data resource that is to be stored in a different peer of the peer-to-peer-overlay network, firstly selects a finger peer in the peer-to-peer overlay network whose peer identification has the smallest spacing from the keyword of the data resource to be stored.

In one embodiment of the proposed method the peer checks whether the keyword of the data resource to be stored falls within the keyword range of the located finger peer.

In one embodiment of the proposed method it is checked whether the number of data resources stored with the located finger peer has reached a resource threshold limit if the keyword of a data resource to be stored falls within the keyword range of the located finger peer.

In one embodiment of the proposed method the data resource is stored with the located finger peer if this finger peer has not yet reached a resource threshold limit.

In one embodiment of the proposed method it is also checked whether a further peer that is adjacent to the finger peer has already reached a resource threshold limit within the peer-to-peer overlay network if the located finger peer has reached a resource threshold limit.

In one embodiment of the proposed method the data resource to be stored is stored with the peer that is adjacent if it has not yet reached its resource threshold limit.

In one embodiment of the proposed method a finger peer of the selected finger peer is in turn selected whose peer identification has the smallest spacing from the keyword of the data resource to be stored if the keyword of the data resource to be stored does not fall within the keyword range of the selected finger peer.

In one embodiment of the proposed method a peer, which selects a data resource stored in a different peer of the peer-to-peer overlay network, firstly selects a finger peer in the peer-to-peer overlay network whose peer identification has the smallest spacing from the keyword of the sought data resource.

In one embodiment of the proposed method it is checked whether the keyword of the sought data resource falls within the keyword range of the located finger peer.

In one embodiment of the proposed method it is checked whether the number of data resources stored with the located finger peer is greater than or equal to the number of requested data resources.

In one embodiment of the proposed method the requested data resources are output to the searching peer if the number of requested data resources is less than or equal to the number of data resources stored with the located finger peer.

In one embodiment of the proposed method it is iteratively checked whether the total of the number of data resources stored with the located finger peer plus the number of data resources stored with a peer that is adjacent thereto is greater than the number of data resources requested by the searching peer if the number of requested data resources is greater than the number of data resources stored with the located finger peer.

In one embodiment of the proposed method a finger peer of the located finger peer is selected whose peer identification has the smallest spacing from the keyword of the sought data resource if it is found that the keyword of the sought data resources does not fall within the keyword range of the located finger peer.

In one embodiment of the proposed method the peer-to-peer overlay network has chain-like topology.

In one embodiment of the proposed method the peer-to-peer overlay network has tree-like topology.

In one embodiment of the proposed method the peer-to-peer overlay network has ring-like topology.

In one embodiment of the proposed method the peer-to-peer overlay network is formed by a chord network.

In one embodiment of the proposed method the peer-to-peer overlay network is formed by a Gnutella overlay network.

In one embodiment of the proposed method the peer-to-peer overlay network is formed by a Torrent network.

In one embodiment of the proposed method the peer-to-peer overlay network is formed by a CAN network.

The invention also creates a peer-to-peer network comprising a plurality of peers, which each have an associated keyword range, wherein a data resource to be stored whose keyword is within the keyword range of a peer, is only stored with this peer if the number of data resources stored there has not yet reached an adjustable resource threshold limit.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIGS. 1a, 1b show an example of a known peer-to-peer overlay network with exemplary keyword range distribution,

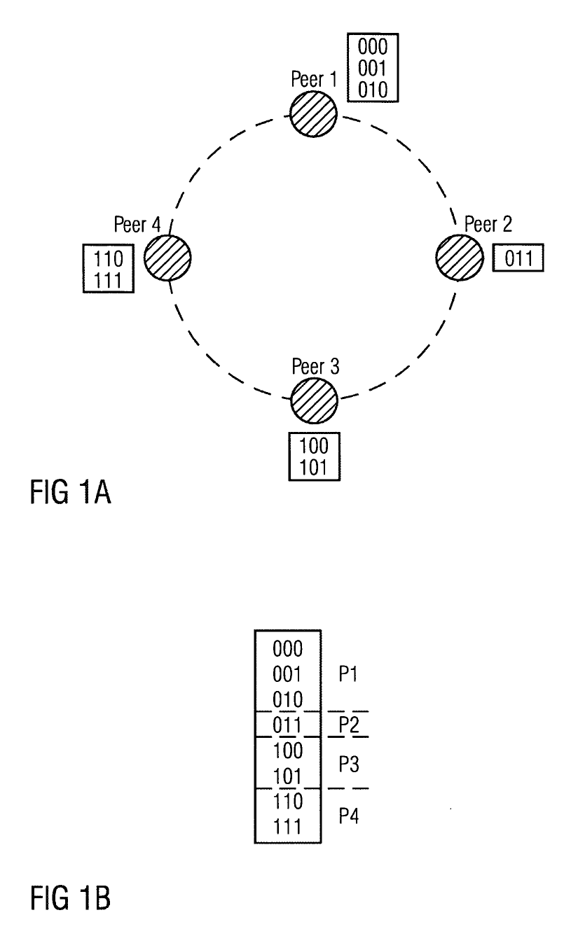

FIGS. 2a, 2b show diagrams of a known search process for locating a peer within the peer-to-peer overlay network shown in FIG. 1a,

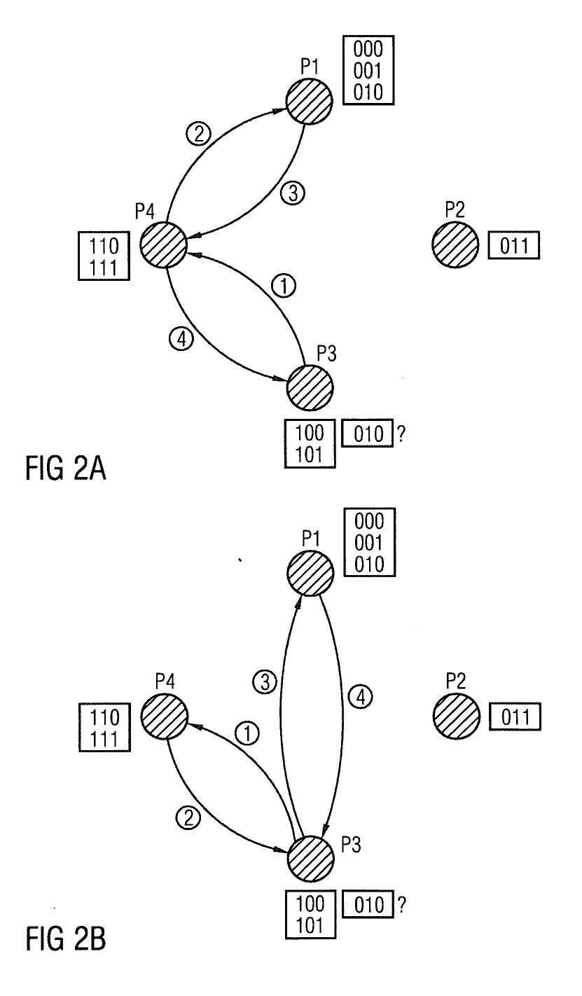

FIG. 3 shows a flow chart to illustrate one possible embodiment of the proposed method for the even load distribution in a peer-to-peer overlay network,

FIG. 4 shows an example of storing a data resource by the inventive method,

FIG. 5 shows a further flow chart to illustrate the proposed method for the even load distribution in a peer-to-peer overlay network,

FIG. 6 shows an example of a search process in which a data resource is sought in a peer-to-peer overlay network by the proposed method.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The idea underlying the proposed method for the even load distribution in a peer-to-peer overlay network comprising a plurality of peers is to distribute data resources with the same keywords among a plurality of peers in such a way that firstly a predefined topology of the peer-to-peer overlay network is adhered to and secondly the number of stored data resources per peer is limited. The load, which is produced by both the administration and locating of data resources, can be distributed among a group of peers hereby.

In the proposed method storing or publication of data resources is successively executed by peers. If a peer has reached a resource limit or a resource threshold limit the filled peer refers to the next peer within the peer-to-peer overlay network. If, for its part, this peer is used to capacity it refers to the next adjacent peer. If all peers of the peer-to-peer overlay network have reached their resource threshold limit then in one embodiment the memory capacity for storing the data resource per peer can be increased or storing of data resources or their publication is refused. The sequence in which peers-to-peers are filled depends on the topology of the underlying peer-to-peer overlay network. The topology of the peer-to-peer overlay network can be chain-like, tree-like or ring-like.

In one possible embodiment of the proposed method a ring-like Chord peer-to-peer overlay network is used.

In alternative embodiments a Gnutella overlay network, a Torrent network or a CAN peer-to-peer overlay network can be used.

When searching for a data resource the searching peer can make use of the topology of a group of storing peers in order to efficiently find a peer which can respond to the search request. If a relatively large number of data resources should be located the searching peer receives information from the peers to be stored about the peer within the storing group of peers on which additional data resources may be found. The query sequence is established in this case by using the topology of the peer-to-peer overlay network. This allows an iterative search for data resources which is not possible with centrally administered database systems.

In the proposed method for the even load distribution in a peer-to-peer overlay network a data resource to be stored, whose keyword is within the keyword range of the peer, is stored with this peer only if the number of data resources stored there has not yet reached a resource threshold limit. In one embodiment of the proposed method the resource threshold limit can be individually adjusted for each peer. In an alternative embodiment all peers of the network have the same resource threshold limit. The keywords used are preferably hash values which are derived from data of the data resource by a predefined hash function.

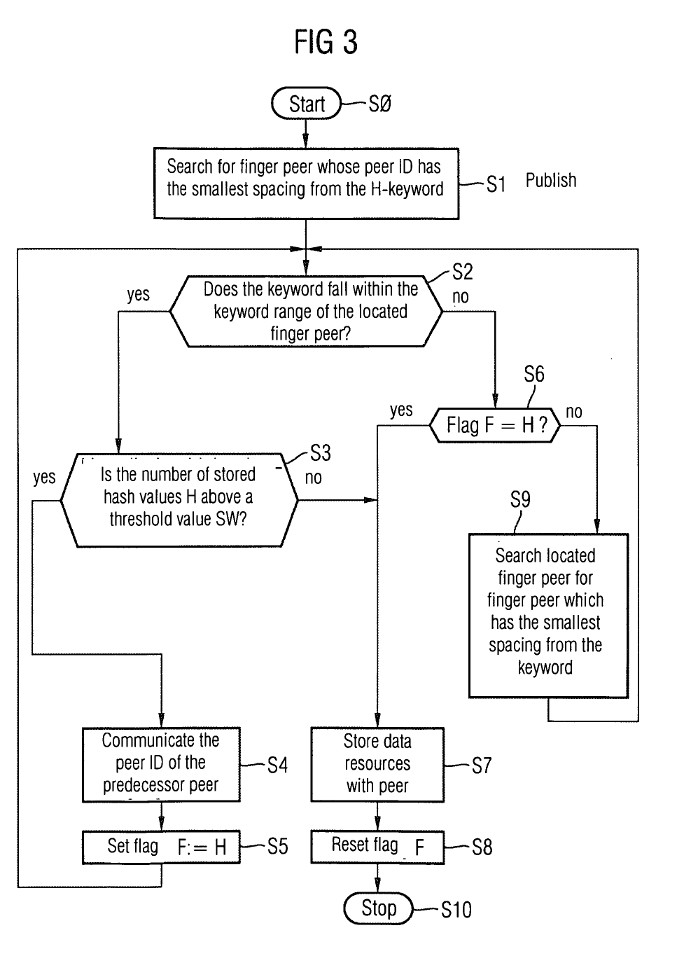

FIG. 3 shows the publication or storing of a data resource within a peer-to-peer overlay network, for example a ring-like port-peer-to-peer overlay network.

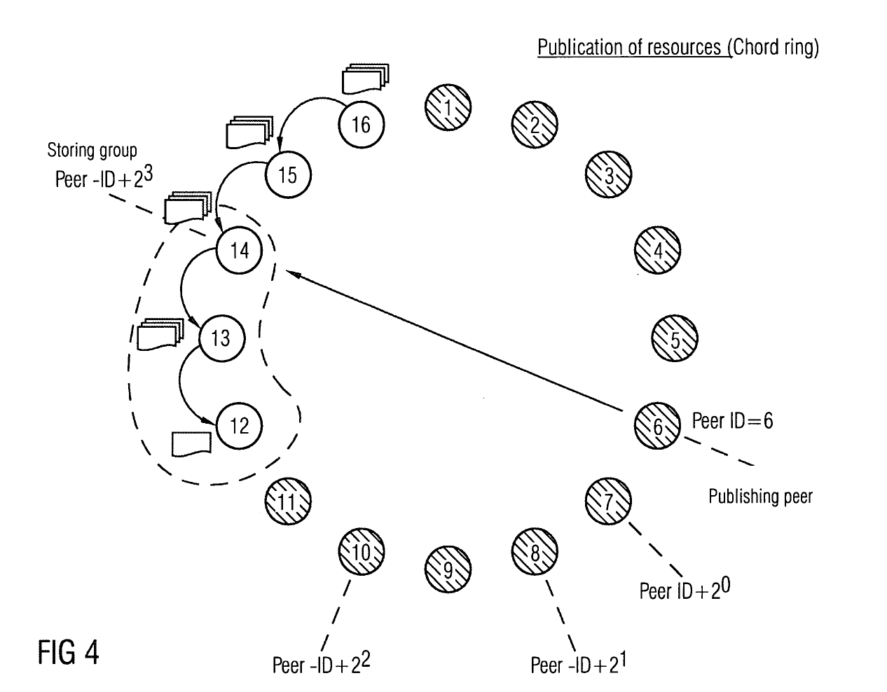

FIG. 4 shows the publication procedure of a data resource using the example of a Chord ring with sixteen peers P1-P16. If a peer P wants to store a data resource in a different peer P of the peer-to-peer network it firstly searches in step S1 for a finger peer whose peer identification has the smallest spacing from the keyword of the data resource. The keyword can be a hash value H for example, which is derived from a predefined name for the data resource, such as “landscape” or “Mueller” for example, or from the data resource itself. Each peer within the peer-to-peer overlay network has a clear peer identification which is a virtual address. In the exemplary ring structure of a peer-to-peer overlay network shown in FIG. 4 each of the sixteen peers P1-P16 has a clear peer ID. If, for example, peer no. 6 with peer ID=6 wants to store or file a data resource in a different peer P of the overlay network it calculates with the aid of the data or a predefined file name a keyword or a hash value H for the data resource to be stored. The hashed value H can be a character chain comprising 128 characters for example.

Firstly the searching peer P6, i.e. the peer with peer no. 6, searches for an associated finger peer, whose peer ID has the smallest spacing from the keyword, i.e. from the calculated hash value H. The following applies to the peer ID of a finger peer:

Peer_{Finger-Peer}=Peer-ID+2^{K}.

In the example shown in FIG. 4 the finger peers for the searching peer no. 6 are formed by the peers with the peer IDs 7, 8, 10 and 14.

According to FIG. 3 the peer P which wants to store the data resource searches accordingly in step S1 for the finger peer whose peer identification has the smallest spacing from the formed keyword of the data resource to be stored. It is then checked in step S2 whether the keyword of the data resource to be stored falls within the keyword range of the located finger peer. By way of example the finger peer with peer ID 14 is selected and it is then checked whether the keyword falls within the keyword range thereof.

If this is the case, i.e. the keyword of the data resources to be stored falls within the keyword range of the located finger peer, it is also checked whether the number of data resources stored with the located finger peer has already reached the resource threshold limit of the peer set or configured there or not.

If the located peer still has storage space the data resource is stored with this peer in step S7. If, conversely, the storage capacity of the selected finger peer is exhausted, it communicates the peer ID of its predecessor peer within the peer-to-peer overlay network to the searching peer P6 with peer ID no. 6. In the ring-like Chord peer-to-peer overlay network shown in FIG. 4 for example the located finger peer P14 communicates the peer ID of the predecessor peer with peer ID no. P13 to the searching finger peer P6.

A display flag F is then set in step S5.

If the formed keyword or key of the data resource to be stored does not fall in the keyword range of the located finger peer, for example finger peer no. 14, it is checked in step S6 whether the display flag F is set or not. If the display flag F is set the data resource is stored in step S7 with the displayed predecessor peer no. 13. The display flag F is then reset in step S8 and the process ends in step S10. If, conversely, it is found in step S6 that the display flag F is not set, the finger peer is searched for in the located finger peer, for example in finger peer P14, which in turn has the smallest spacing from the keyword of the data resource to be stored. The process then returns to step S2. Adjacent peers within the peer-to-peer overlay network are thus successively filled with data resources. In the example shown in FIG. 4 the peers P14, P13 and P12 are successively filled and form a memory group for data resources which have the same keyword.

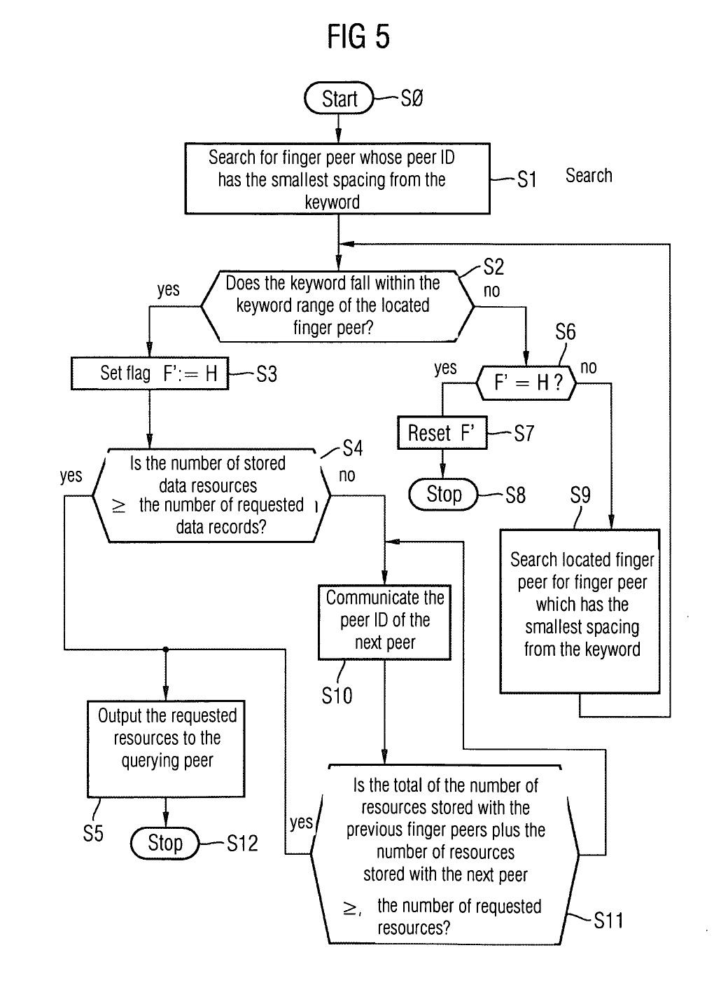

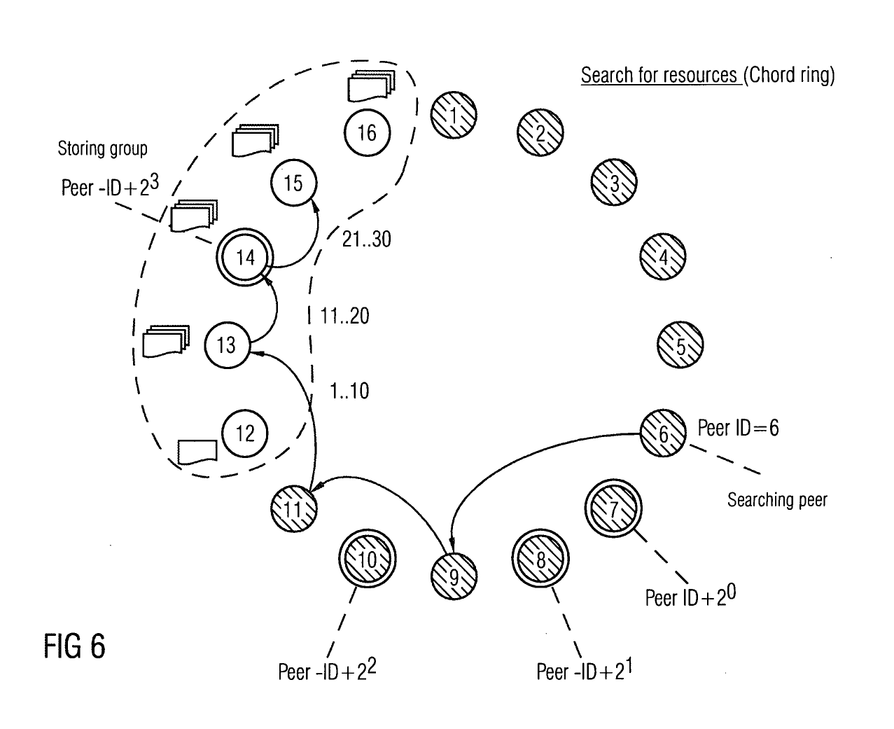

FIG. 5 shows a flow chart to illustrate a search process to search for a data resource within a peer-to-peer overlay network in one possible embodiment of the proposed method. FIG. 6 shows a simple example of a peer-to-peer overlay network with Chord ring structure.

In a step S1 firstly the peer is sought whose peer ID has the smallest spacing from the formed keyword.

It is then checked in step S2 whether the formed keyword falls within the keyword range of the located peer P. If this is the case a display flag F′ is set in step S3.

It is then checked in step S4 whether or not the number of data resources stored with the located peer P is greater than the number of data resources requested by the searching peer. If the number of stored data resources is sufficient, i.e. greater than the number of requested data records, the requested data resources are supplied to the querying peer in step S5. If, conversely, the number of stored data resources is not sufficient, reference is made in step S10 to the adjacent peer of the peer-to-peer overlay network. The total of the number of stored data resources of the previously located peers and the number of data resources stored with the next peer is then formed and compared with the number of requested data resources. As soon as the total exceeds the number of requested data resources, the requested data resources are supplied to the querying peer from the various peers of the memory group.

If during the search process in step S2 it is found that the keyword does not fall within the keyword range of the located finger peer, it is checked in step S6 whether the display flag F′ is set or not. If it is set, it is reset in step S7. If it is not set, in relation to the located finger peer, the finger peer is searched for in step S9 whose peer ID has the smallest spacing from the keyword of the sought data resource and the method then returns to step S2.

In the illustrated example the topology of the storing peer group corresponds to a circular segment of the Chord ring. A group of storing peers is formed by referring to a neighbor peer with the next smaller index when a peer is overflowing and, more precisely, until a suitable peer is located. In an alternative embodiment the outer edge of the group, i.e. the length of the annular section, can be buffered. In this case the position of the outer peer is filed for example with the peers along the various paths in the group and updated during the search or publication. As the path length is logarithmically scaled with the ring size and publishing or searching peers only update the values of one path respectively, the effort is also logarithmic here. Although it is relatively improbable for the buffered value to refer directly to the outer peer of the group, buffering is a very good approximation. If the group edge in this embodiment should not be directly affected it can in turn be determined as described above using linear effort.

In the proposed method a searching peer P, in order to locate a stored data resource, firstly has to localize the storing group. For this purpose the peer responsible for the keyword range is firstly ascertained. It is also checked for each hop whether the respective peer P is already part of the group. As soon as a peer of the group is reached the request is evaluated and resources optionally supplied back to the searching peer. As the paths of the searching peers to the storing peers are different, the request load is distributed among different peers within the group in each case. Even better distribution is achieved if the searching peer takes the position of the annular section from the buffered values and selects a path direct to a randomly selected peer of the group.

If in the proposed method more data resources are requested during the search than can be provided by an individual peer, the peer refers to the adjacent peer with the next greater or smaller index. Successive forwarding of the request within the group allows an iterative search by way of the volume of all data resources of a specific keyword.

A balancing of the search and administration load of resources in peer-to-peer systems is achieved with the proposed method. Successive filling of the peers with resources leads to the formation of groups for load distribution. This property prevents the formation of what are known as hotspots independently of the frequency distribution of the respective resource keywords. Successive forwarding of a request within a group in the proposed method allows an iterative search by way of the volume of all data resources of a specific keyword. Peer applications can use these properties to search in very large resource volumes. It is therefore possible for users to “browse” large results lists.

One application example for the proposed method for the even load distribution in a peer-to-peer overlay network comprising a plurality of peers is in the field of dissemination of digital media. In this case the data are stored in a Chord-based peer-to-peer overlay network and can be located via meta information, for example via the title, actor, genre, etc. A clear identifier may also be allocated to each medium, e.g. a film. Overloads primarily occur in the case of the genre keywords but also in the case of titles and names of known actors as well as very popular films. Most households, moreover, have an asynchronous internet connection, i.e. a relatively high download bandwidth with a simultaneously low upload bandwidth, so the transmission of films in real time requires more than one peer as the data transmitter. For this purpose the data are distributed among various peers. A plurality of search processes are therefore required to receive a video stream. In a first search process the sought film is located via its metadata description. In a second search process transmitter peers are sought via a clear identifier. Peers which have received the sought film once completely can in turn send it to other peers, so the number of published data resources constantly increases. Depending on the popularity of the sought content or film there can be a very large number of data resources for a specific identifier. This would lead to overloading of individual peers with a normal Chord peer-to-peer network. The even load distribution of the data resources by the proposed method distributes the search and administration load and therefore prevents overloading of individual peers within the peer-to-peer overlay network. The above-cited example may easily be transferred to other fields of application. A hotspot produced by the name of an actor can be attributed for example to the natural unequal distribution of forenames and surnames. The same problem occurs with distributed address books and telephone books as well as business directories such as the Yellow Pages. In all of these fields of application the proposed method is suitable for even load distribution to avoid hotspots or overloading of individual peers.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-25. (canceled)

26. A method for even load distribution in a peer-to-peer overlay network including a plurality of peers, each having an associated keyword range, the method comprising:
separately and individually setting a resource threshold limit of each of the plurality of peers; and
storing a data resource having a keyword within a keyword range of a first peer, at the first peer, if the number of data resources stored at the first peer has not reached the resource threshold limit of the first peer.

27. The method as claimed in claim 26, wherein if the resource threshold limit of the first peer has been reached, the first peer refers to a second peer that is adjacent in a search path in the peer-to-peer-overlay network.

28. The method as claimed in claim 26, wherein a hash value is derived from the keyword.

29. The method as claimed in claim 26, wherein a second, adjacent peer is a subsequent peer in the peer-to-peer overlay network.

30. The method as claimed in claim 26, wherein if the data resource is not stored in the first peer, the first peer causes the data resource to be stored in a second peer, the second peer being a finger peer to the first peer in the peer-to-peer-overlay network, and
the first peer selects the second peer if a peer identification for the second peer has a smallest spacing from the keyword of the data resource.

31. The method as claimed in claim 30, wherein the first peer checks whether the keyword of the data resource falls within the keyword range of the second peer.

32. The method as claimed in claim 31, wherein it is checked whether the number of data resources stored with the second peer has reached a resource threshold limit when the keyword of the data resource falls within the keyword range of the second peer.

33. The method as claimed in claim 32, wherein the data resource is stored with the second peer if the second peer has not reached its resource threshold limit.

34. The method as claimed in claim 33, wherein it is checked whether a third peer that is adjacent to the second peer in a search path has already reached its resource threshold limit within the peer-to-peer overlay network when the second peer has reached its resource threshold limit.

35. The method as claimed in claim 34, wherein the data resource is stored with the third peer that is adjacent to the second peer in the search path if the resource threshold limit of the third peer has not yet been reached.

36. The method as claimed in claim 31, wherein a third peer of the second peer is selected for the storage of the data resource if the peer identification of the third peer has a smallest spacing from the keyword of the data resource when the keyword of the data resource does not fall within the keyword range of the second peer, the third peer being a finger peer of the second peer.

37. The method as claimed in claim 26, wherein if the data resource is not stored in the first peer, the first peer searches for and selects a data resource stored in a second peer of the peer-to-peer overlay network, and the first peer selects the second peer in the peer-to-peer overlay network if a peer identification of the second peer has a smallest spacing from the keyword of the sought data resource, the second peer being a finger peer to the first peer.

38. The method as claimed in claim 37, wherein it is checked whether the keyword of the sought data resource falls within the keyword range of the second peer.

39. The method as claimed in claim 38, wherein it is checked whether the number of data resources stored with the second peer is greater than or equal to a number of sought data resources.

40. The method as claimed in claim 39, wherein the sought data resources are output to the first peer when the number of sought data resources is less than or equal to the number of data resources stored with the second peer.

41. The method as claimed in claim 39, wherein it is checked whether a total of the number of data resources stored with the second peer plus a number of data resources stored with a third peer that is adjacent thereto is greater than the number of data resources sought by the first peer when the number of sought data resources is greater than or equal to the number of data resources stored with the second peer.

42. The method as claimed in claim 38, wherein a third peer of the second peer is selected for the storage of the data resource if the peer identification of the third peer has a smallest spacing from the keyword of the sought data resource if the keyword of the sought data resource does not fall within the keyword range of the second peer.

43. The method as claimed in claim 26, wherein the peer-to-peer overlay network has chain-like topology.

44. The method as claimed in claim 26, wherein the peer-to-peer overlay network has tree-like topology.

45. The method as claimed in claim 26, wherein the peer-to-peer overlay network has ring-like topology.

46. The method as claimed in claim 26, wherein the peer-to-peer overlay network is formed by a chord network.

47. The method as claimed in claim 26, wherein the peer-to-peer overlay network is formed by a Gnutella overlay network.

48. The method as claimed in claim 26, wherein the peer-to-peer overlay network is formed by a Torrent network.

49. The method as claimed in claim 26, wherein the peer-to-peer overlay network is formed by a controller area network.

50. A peer-to-peer network, comprising:
a plurality of peers, each having an associated keyword range, a resource threshold limit being separately and individually set for each of the peers,
wherein a data resource having a keyword within a keyword range of one of the peers is stored with the peer if the number of data resources stored at the peer has not reached the adjustable resource threshold limit of the peer.
